(19) United States
(12) Patent Application Publication
(10) Pub. No.: US 2004/0002162 A1
(43) Pub. Date: Jan. 1, 2004

(54) Transmission infrared spectroscopy array and method

(76) Inventors: Mary Anne Leugers, Midland, MI (US); David R. Neithamer, Midland, MI (US); Jack E. Hetzner, Reese, MI (US); Matthew L. Krause, Midland, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/465,428

(22) Filed: Jun. 19, 2003

Related U.S. Application Data
(60) Provisional application No. 60/392,739, filed on Jun. 27, 2002.

(51) Int. Cl. B32B 27/04; G01N 21/62

(52) U.S. Cl. 436/171; 422/102

(57) ABSTRACT

A sample holding array is provided which is particularly advantageous for various IR and near IR transmission spectroscopy analysis that yields high quality spectra with minimal artifacts. The sample holding array may also be used desirably with slight modifications for Raman analysis, x-ray fluorescence and nanoindentation.

### CROSS REFERENCE TO RELATED APPLICATION

This application claims the benefit of U.S. Provisional Application No. 60/392,739, filed Jun. 27, 2002.

### BACKGROUND TO THE INVENTION

With the emergence of reaction tools for combinatorial chemistry, new characterization methods have been developed that hold considerable promise in speeding the process to identify attractive catalysts and reactions. This combination of synthesis tools and characterization tools allows the simultaneous generation and testing of a large number of compounds. Infrared (IR) spectroscopy is a powerful, universal tool for the characterization of polymers, proteins and many types of materials. A wide variety of infrared-based techniques have been investigated for interfacing the sample to the infrared beam of light used for high throughput analyses. An excellent review of the technology highlights several recent publications addressing this need is found in the journal article “Combinatorial chemistry: A tool for the discovery of new catalysts”, Wennemers, Helma, Comb. Chem. High Throughput Screening (2001), 4(3), 273-285. These techniques have not only been applied successfully to the high-throughput screening of parallel compound arrays but also to the screening of compound libraries developed from reactions and analysis of materials on microbeads.

While IR micro-bead analysis has been used extensively as a characterization tool in the pharmaceutical industry, other approaches are more effective for the analysis of macro-sized samples that are produced in materials and catalysis research. Fourier transform IR spectroscopy using attenuated total reflection devices (ATR-FTIR spectroscopy) in conjunction with multivariate calibration have been employed to determine the composition of olefin copolymers such as ethylene/1-hexene and ethylene/1-octene copolymers as described in the journal article “High-throughput evaluation of olefin copolymer composition by means of attenuated total reflection fourier transform infrared spectroscopy”, Tuchbreiter, Arno; Marquardt, Juergen; Zimmermann, Joerg; Walter, Philipp; Muelhaupt, Rolf; Kappler, Bernd; Faller, Daniel; Roths, Tobias; Honerkamp, Josef, J. Comb. Chem. (2001), 3(6), 598-603. While ATR-FTIR spectroscopy has some advantages in terms of its flexibility with respect to sample geometry, the variation in the refractive index of the samples, the pressure of the crystal against the samples, and the long-term crystal abrasion can produce variables in the spectra which must be modeled using multivariate modeling approaches.

Snively and co-workers developed a major technology improvement in the characterization of catalytic activity using FTIR imaging approaches as described in the following journal articles: “Fourier-transform infrared imaging using a rapid-scan spectrometer”, Snively, C. M.; Katzenberger, S.; Oskarsdottir, G.; Lauterbach, J., Opt. Lett. (1999), 24(24), 1841-1843; “Chemically sensitive parallel analysis of combinatorial catalyst libraries”, Snively, C. M.; Oskarsdottir, G.; Lauterbach, J., Catal. Today (2001), 67(4), 357-368; and “Parallel analysis of the reaction products from combinatorial catalyst libraries”, Snively, Chris M.; Oskarsdottir, Gudbjorg; Lauterbach, Jochen, Angew. Chem., Int. Ed. (2001), 40(16), 3028-3030. The advancement described in these journal articles dramatically decreases the time required for data collection without decreasing the data quality. With this new instrumental setup, an imaging data set consisting of 64×64 spectra with a 4 cm⁻¹ spectral resolution over a 1360 cm⁻¹ spectral range can be collected in 34 seconds. As a practical example, these authors demonstrated what they believe to be the 1st application of FTIR imaging to the screening of adsorbates on the elements of a combinatorial library containing different supported catalyst materials supplied with the same reactant feed. This group has used the technology for the sensitive detection of reaction energies on catalyst libraries. It is used to identify catalytic activity of library components through the heat of reaction with high efficiency. This method has been applied to total oxidation, selective oxidation and hydrogenation reactions. However, it has not been suggested to use this approach for the analysis of polymers produced in these arrays.

Photoacoustic FT-IR (PA-FTIR) requires no sample preparation and can give high quality spectra with minimal artifacts, as described in the journal article “Photoacoustic FTIR spectroscopy, a non-destructive method for sensitive analysis of solid-phase organic chemistry”, Gosselin, Francis; Di Renzo, Mauro; Ellis, Thomas H.; Lubell, William D., Book of Abstracts, 213th ACS National Meeting, San Francisco, Apr. 13-17, 1997, ORGN-569. Publisher: American Chemical Society, Washington, D. C. In PA-FIR, a sensitive microphone measures an acoustic wave created by absorbed radiation diffusing as heat through the sample towards a boundary layer of gas. By detecting only absorbed radiation via sound waves, PA-FTIR spectroscopy eliminates the spectral artifacts of light scattering and reflection. Also demonstrated is the use of PA-FTIR to effectively monitor the modification of solid supports as well as syntheses of polymer-bound organic compounds. A serious limitation of this approach is that photoacoustic FTIR spectroscopy requires phase or amplitude modulation. The phase delay chosen will select various depths of the sample and therefore problems may arise with respect to interpretation of the signals produced.

Feustel described in the journal article “IR analysis in combinatorial chemistry”, Feustel, Manfred; Henkel, Bernd, LaborPraxis (2001), 25(6), 28,30-32, the use of a Pike Technology XY auto-sampler for the direct IR spectroscopic analysis of liquids, powered solids, micro-beads, and solid samples in 96-well microtiter plates. The beam diameter at the focus was approximately 2 mm and measurements were performed in the diffuse reflection mode. This approach is frequently problematic because band shapes are frequently distorted and are very difficult to quantitate.

The use of an arrayed wafer to determine the infrared spectra of a plurality of polymeric materials is described in “Polymeric libraries on a substrate, method of forming polymer libraries on a substrate and characterization methods with the same”, Boussie, Thomas R.; Devenney, Martin, Symyx Technologies, Inc., EP 1160262 (2001). A polished silicon wafer containing an array of 3 mm gold dots is described. The silicon surface is treated with a silanizing reagent to increase the surface energy and render a non-wettable silicon surface. Polymer samples are deposited onto the gold dots of the wafer via evaporative deposition of heated polymer solutions. Reflectance FT-IR spectroscopic methods are then used for analysis. However, this approach presents severe problems with regard to fringes produced in the spectra from thin, flat films on a reflective surface. While programmable mapping stages can be applied it adds complexity and uncertainty to the method. Alternatively this group proposes using a transmission substrate with transmission holes through the substrate into which the polymer “flows” or is transported. The problem with this approach is that the hole diameter would detrimentally constrain the beam geometry of the infrared instrument. In addition, the polymer viscosity would vary with molecular weight and the transport of material into that capillary would be highly variable leading to path length differences and concentration differences. These problems which are inherent with the design of this instrument would lead to highly inaccurate analytical results.

Given the choice between various IR methods, transmission spectroscopy of macro-sized samples always yields the highest quality spectra with minimal artifacts if sample thickness is controlled. However, the prior art has not suggested a suitable approach for performing IR transmission spectroscopy in a sample array while yielding essentially no fringes or interfering artifacts.

### OBJECTS OF THE INVENTION

It is an object of this invention to provide an effective approach for performing IR transmission spectroscopy in a sample array while yielding essentially no fringes or interfering artifacts.

It is also another object of the invention to provide a sample holding array for use in infrared and near infrared analysis which provides high quality, reliable spectra on a multiplicity of samples with unattended operation.

It is a more specific objective of the invention to provide such an array which provides the properties of essentially no detrimental baseline artifacts such as spectral fringes which can limit the quantitation ability of the analysis.

It is yet a more specific objective of the invention to provide an array having the foregoing attributes and which may also be operated at relatively high temperatures in order to deposit hot polymer solutions in the array for analysis.

It is still another objective of the invention that the sample holding array be robust so that it can be cleaned and reused many times for multiple sample libraries.

Another objective of the invention is to employ an array comprising a substrate that requires only one reference spectrum per sample array.

It is yet another objective of the invention to provide an array that may serve dual purposes and uses for sample analysis by infrared spectroscopy and with slight modifications by Raman spectroscopy, x-ray fluorescence spectroscopy and/or nanoindentation analysis.

Yet another objective of the invention is to provide improved combinatorial methods of an analysis using the sample holding array of the invention.

### A BRIEF SUMMARY OF THE INVENTION

One aspect of the invention is the provision of a highly advantageous sample holding array for retaining multiple samples for the purpose of infrared or near infrared transmission spectroscopy comprising:

(1) a sample support which is at least partially transparent to infrared and near infrared radiation, the support having a first generally planar surface and a second opposed generally planar surface, the support being constructed of a material of the group consisting essentially of silicon, germanium, zinc sulfide, cadmium telluride, AMTIR-1 (a highly homogeneous amorphous material with the composition of Ge₃₃As₁₂Se₅₅), sapphire, KRS-5 (thallium bromoiodide) or zinc selenide, the material of construction not containing impurities significantly detrimental to transmission of infrared or near infrared radiation through the thickness of the support, the support having a thickness which allows sufficient IR transmission to allow infrared and near infrared radiation transmission through the support for the purpose of spectroscopic analysis, and

(2) an array of individual sample cavities defined adjacent to said first planar surface of the support, the cavities being in optical communication with the second planar surface of the support whereby infrared or near infrared radiation can be transmitted through the thickness of the support for the purpose of spectroscopic analysis of samples contained in said sample cavities, respectively.

Yet a more specific aspect of the invention comprises such a sample holding array and further comprising:

(1) a first substrate which forms said sample support; and

(2) at least one adhesive coating layer bonded to the first generally planar surface of the first substrate;

(3) a second substrate having a first generally planar surface and an opposed second surface, the first surface of the second substrate being bonded to the first surface of the first substrate through the adhesive layer; wherein

(4) the second substrate defines a plurality of openings extending between the first and second surfaces thereof and forms with the first surface of the first substrate an array of sample holding cavities, the portion of the first surface of the first substrate forming a part of the sample holding cavities being generally free of said adhesive layer to facilitate transmission of infrared and near infrared radiation through the first substrate into the interior of the sample holding cavities.

Yet another aspect of the invention is to provide a method of infrared or near infrared analysis comprising placing sample in the sample cavities of the sample holding array as described above, irradiating the sample through the first substrate, and detecting the transmitted radiation passed through the sample material.

Still another aspect of the invention is to provide a method of Raman analysis comprising applying a coating selected from the group consisting of gold, silver, platinum, chromium, molybedium, tungsten, cobalt, nickel, copper, palladium, or aluminum walls of the cavities of the sample holding array as described above, placing a sample in the cavities, irradiating the sample cavities with laser radiation, and detecting the Raman back scatter to characterize the samples.

Yet another aspect of the invention is to provide a method of x-ray fluorescence analysis comprising placing sample in the sample cavities of the sample holding array as described above, irradiating the sample cavities with x-ray radiation, and detecting the fluorescence back scatter to characterize the samples.

Another aspect of the invention is to provide a method of nanoindentation comprising placing sample in the sample cavities of the sample holding array as described above, and contacting the sample with a nanoindenting probe for the purpose of measuring one or more physical material properties of the sample.

Further aspects, details, objects, features, and advantages of the invention will be appreciated from a consideration of the Drawing and the Detailed Description.

### BRIEF DESCRIPTION OF THE FIGURES

FIG. 1 is a plan view of a sample holding array constructed according to the principles of the invention.

FIG. 2 is a cross-sectional view of a sample holding array showing the detailed construction of a preferred embodiment of the array.

FIG. 3 is another cross sectional view of a sample holding array which has been modified to permit reflectance spectroscopy analysis such as Raman spectroscopy or x-ray fluorescence.

### DETAILED DESCRIPTION OF THE INVENTION

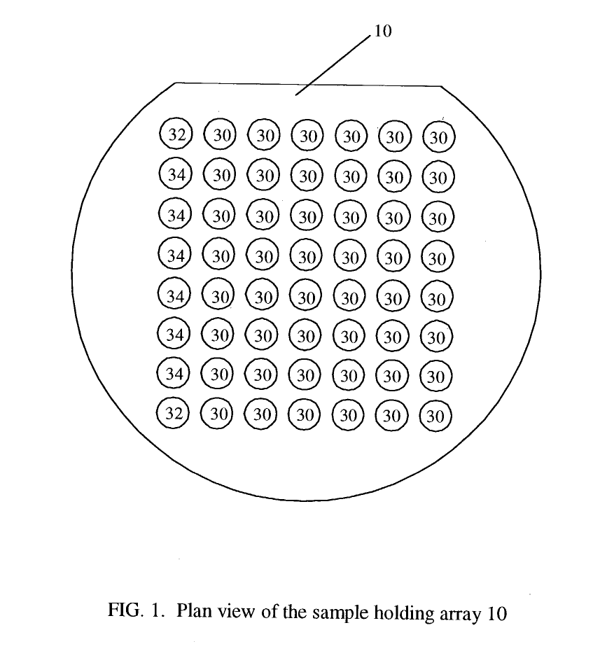

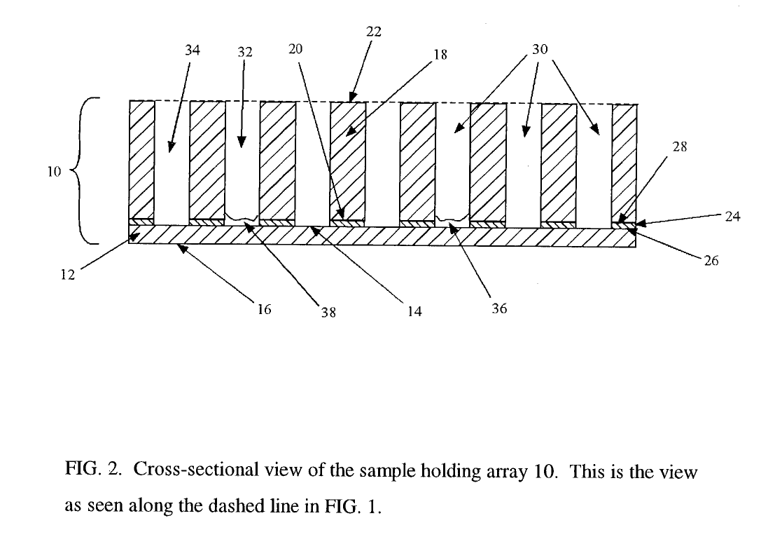

Referring to FIGS. 1 and 2, there is shown a preferred embodiment of a sample holding array generally designated by Reference Numeral 10 for retaining multiple samples for the purpose of infrared or near infrared transmission spectroscopy. The sample holding array 10 comprises a sample support or first substrate 12 which is at least partially transparent to infrared and near infrared radiation. The sample support 12 comprises a first generally planar surface 14 and a second opposed generally planar surface 16.

The sample array 10 additionally comprises a second substrate 18 having a first generally planar surface 20 and an opposed second surface 22, the first surface 20 of the second substrate 18 being bonded to the first surface 14 of the first substrate 12 by a preferably high temperature adhesive system 24. By high temperature, it is intended that the adhesive system be able to operate at temperatures of about 160 degrees Centigrade or greater. Exemplary of an adhesive system which provides such performance is the system described in detail in Example 1. The adhesive system 24 comprises an optional first layer 26 of an adhesion promoting material applied to the first surface 14 of the first substrate 12 and an adhesive coating layer 28. The adhesive coating layer 28 is used to securely bond the first surface 14, with the aid of the adhesion promoting material 26, to the first surface 20 of the second substrate 18.

The second substrate 18 defines a plurality of openings extending between the first and second surfaces 20 and 22 thereof and forming with the first surface 14 of the first substrate 12, an array of sample holding cavities or wells 30, 32, and 34. The cavities designated by Reference Numeral 30 are intended for holding samples for analysis. Those designated by Reference Numeral 32 are for holding standard reference samples so that the infrared signal transmitted through the cavities 30 can be compared with the reference to check the validity of the measurement. The cavities 34 are used to record the spectral reference background. The cavities 34 are therefore empty of material to provide background subtraction of the first substrate 12 according to the known practice.

In the particular embodiment of the invention shown in FIG. 1, there is provided an array of fifty six cavities or sample cells or wells of which forty eight are sample holding cavities 30, six are reference cavities 32, and two are background cavities 34. The selection of the cavities, which provide these various functions, is arbitrary and can be changed from that shown in the drawing. In addition, the number of cavities is not critical and can be changed by adding or reducing the number of cavities from that shown in the FIG. 1.

The size of the sample cavities is also not critical. The minimum size is sufficient to hold the volume of sample desired for analysis. Typically for macro-size samples, the volume of the cavity will need to be at least about five to one hundred microliters depending on the sample material needed for the particular analysis technique. Thus a cavity size of one hundred microliters provides flexibility to analyze those materials, which require relatively high amounts of volume, but the same larger cavity can also be used with samples that require only five microliters.

The dimensions of each cell are critical only from the standpoint that the diameter of the cell adjacent the first surface 14 of the substrate 12 must be wide enough to allow passage of the width of the infrared beam used in the analysis. The desired volume of the sample material to be analyzed determines the depth of each cavity once the width dimension is fixed.

The material of construction of the first and second substrates 12 and 18 can be the same or can be different. An important aspect of the invention is to use a first substrate 12 which is constructed of silicon, germanium, zinc sulfide, cadmium telluride, AMTIR-1, sapphire, KRS-5 or zinc selenide. These materials should not contain impurities which are detrimental to the infrared transmission. Small levels of impurities can be tolerated which do not interfere with the desired analytical results. The thickness of the first substrate 12 is also selected to allow sufficient IR transmission of infrared and near infrared radiation through the thickness of the first substrate 12 such that spectroscopy analysis can be performed on samples retained in the cavities 30 or 32. The thickness of the first substrate 12 is preferably selected to be at the minimum required for the structural integrity of the array. Any additional thickness would provide no beneficial advantage.

The second substrate 18 allows for a greater variety in the selection of the material because it does not need to be transmissive of infrared or near infrared radiation. It needs to be non-reactive, thermally stable and bondable through an appropriate adhesive system 24 to the first substrate 12. Materials of construction for the second substrate 18 include, but are not limited to, metal oxides, metal nitrides, metals, silicon, germanium, zinc sulfide, cadmium telluride, AMTIR-1, sapphire, KRS-5, silicon dioxide, zinc selenide and the like. It is highly preferred, however, to make the second substrate 18 of the same material of the first substrate 12 since these substrates will have the same thermal expansion coefficient reducing strains on the adhesive bond over repeated usage. It is also contemplated that the first and second substrates, 12 and 18, may be formed of a single integral body wherein the cells are fabricated by forming the cell cavities using machining or other fabrication methods. This is a less preferred form of construction because the first surface 14 must be optically polished for infrared radiation transmission. There is also the possibility of different transmission properties between the wells caused by different thicknesses of the first substrate 12. This can be compensated for through calibration techniques but leads to a more expensive and complicated analysis. In the illustrated embodiment of FIGS. 1 and 2, the first substrate 12 is made of a separate piece of material which normally can be obtained within tolerances of uniform thickness which do not require separate calibration of each sample cavity relative to the reference cavities.

In the preferred embodiment, the adhesive system 24 comprising layers 26 and 28 has been removed from the first substrate 12 using a stripping solution.

The method of operation of the sample holding array comprising placing sample 36 in cavities 30 and optionally reference sample material 38 in cavities 32. A beam of infrared or near infrared radiation is impinged on the sample 36 and reference sample material 38 by rotating or translating the sample holding array relative to the beam of infrared or near infrared radiation. The beam, after irradiating the sample, is transmitted through the first substrate 12 and is detected by an infrared or near infrared detector, for example a deuterated tri-glycine sulfate (DTGS) detector and the transmitted radiation used to characterize the samples according to the known methods.

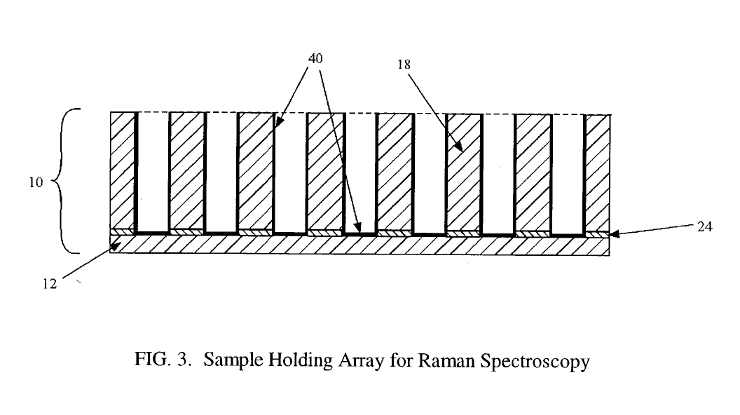

A modification of the sample holding array 10 is shown in FIG. 3 which allows the sample array to be used for reflectance analysis. More specifically, in this modified embodiment of the invention, a coating 40 of a reflective generally inert material (relative to the sample) such as gold, silver, platinum, chromium, molybedium, tungsten, cobalt, nickel, copper, palladium, or aluminum is applied to the wall and bottom of each cavity. The reflective coating may be formed by known methods such as plasma vapor deposition or other similar known methods for applying a thin coating to a substrate. Deposition of the coating also may be accomplished by the techniques known to those of skill in the art, such as those disclosed in U.S. Pat. No. 5,905,356, which is incorporated by reference herein. The provision of the reflective coating allows the versatility of using the sample holding array advantageously for Raman analysis or x-ray fluorescence. In addition, the modified array 10 of FIG. 3 may be used for infrared reflectance analysis but this is not a preferred application due to the tendency to create fringes or fringed baseline.

In the case of Raman analysis the sample material is irradiated with laser light according to the known technique. The back-scattered radiation emitted from the sample 36 is detected using, for example, silicon charge coupled device (CCD) detectors, and the back-scatter radiation used to characterize the samples according to the known methods.

In the case of x-ray fluorescence, the method is practiced similarly with respect to Raman analysis except that the source of radiation is an x-ray emitter, and the detector detects backscatter fluorescence from the sample by the known method.

The sample holding array of the present invention also forms an excellent sample holding array for use in nanoindentation analysis according to the known technique. In this case, samples 36 placed in cavities 30 are analyzed using a probe that is translated to each cavity. The probe is a nanoindentation probe, which allows the physical material properties of the sample such as hardness, loss modulus, storage modulus, creep, stress relaxation, scratch testing, or adhesion to be characterized.

As is readily apparent, the sample holding array 10 from a practical standpoint, satisfies the need for a disposable, archivable, or simple to re-use sample library holder. The sample holder array 10 may be disposed of or cleaned and reused depending on the samples being analyzed.

Depending on how the sample holding array is mounted in the FTIR spectrometer, the sample holding array may be used to hold a variety of materials. Illustrative but not limiting examples are neat liquids, neat liquid polymers, liquid or solid samples in solution, polymer samples in solution, solid polymer samples evaporatively deposited from solution, solid samples compressed in the sample holding cavities under pressure, emulsions, or solid samples. For solutions, the solvent can vary with respect to polarity, volatility, stability, inertness, and reactivity. Typical solvents include, for example, tetrahydrofuran (THF), toluene, hexane, ethers, trichlorobenzene, dichlorobenzene, water, etc. A particular solvent will be chosen such that any absorption bands from the solvent do not obscure the region of analytical interest.

Preferably, polymer samples will be used with the present invention. Polymers can be homogeneous polymer samples or heterogeneous polymer samples, and in either case, comprises one or more polymer components. As used herein, the term “polymer component” refers to a sample component that includes one or more polymer molecules. The polymer molecules in a particular polymer component have the same repeat unit, and can be structurally identical to each other or structurally different from each other. The polymer molecules can be, with respect to homopolymer or copolymer architecture, a linear polymer, a branched polymer (e.g., short chain branched, long-chained branched, hyper-branched), a cross-linked polymer, a cyclic polymer or a dendritic polymer. A copolymer molecule can be a random copolymer molecule, a block copolymer molecule (e.g., di-block, tri-block, multi-block, taper-block), a graft copolymer molecule or a comb copolymer molecule. The particular composition of the polymer molecule is not critical, and can include repeat units or random occurrences of one or more of the following, without limitation: polyethylene, polypropylene, polystyrene, polyolefin, polyimide, polyisobutylene, polyacrylonitrile, poly(vinyl chloride), poly(methyl methacrylate), poly(vinyl acetate), poly(vinylidene chloride), polytetrafluoroethylene, polybutadiene, polyisoprene, polyacrylamide, polyacrylic acid, polyacrylate, poly(ethylene oxide), poly(propylene oxide), poly(ethyleneimine), polyamide, polyester, polyurethane, polysiloxane, polyether, polyphosphazine, polymethacrylate, and polyacetals. Biological polymers, such as proteins and polysaccharides, are also included within the scope of invention.

The polymer samples in the cavities may also be formed in the cavities upon the polymerization of liquid or solid monomers separately deposited in the cavities. These include addition polymerization, condensation polymerization, step-growth polymerization, chain-growth polymerization reactions, and grafting reactions. With respect to the mechanism, the polymerization reaction can be radical polymerization, ionic polymerization (e.g., cationic polymerization, anionic polymerization), and/or ring-opening polymerization reactions, among others.

In preferred embodiments, the material deposited on the substrate is a polymer of one or more olefins and or acetylenes. The monomers that are polymerized to form the polymers to be deposited herein include linear, cyclic and branched olefins. The olefins may contain more than one double bond and may also contain one or more heteroatoms. Preferred olefin monomers include molecules comprising up to 40 carbon atoms and optionally comprising one or more heteroatoms. Preferred olefin monomers include ethylene, propylene, butylene, isobutylene, 1-pentene, isopentene, cyclopentene, pentadiene, 3-methyl-1-pentene, 2-methylpentene, 4-methyl-1-pentene, cyclopentadiene, hexene, isohexene, hexadiene, cyclohexene, 1-heptene, cycloheptene, heptadiene, 1-octene, cyclooctene, octadiene, nonene, decene, isodecene, cyclodecene, decadiene, dodecene, styrene, butadiene, isoprene, and the like. The monomers may also comprise polar monomers such as acrylic acids, acrylates, alkyl acrylates, vinyl chlorides, acrylonitriles, vinyl acetates, acrylamides and the like. Preferred polymers comprise polymers of ethylene and/or propylene and a C4, to C40 alpha olefin. Preferred alpha olefins include propylene, butene, isoprene, isobutylene, octene, hexene, styrene and the like. The polymers to be deposited herein may be plastics, plastomers, elastomers, oils, waxes or the like. The polymers may have a weight average molecular weight of from about 100 to 2 million or more. The molecular weight desired will be determined by the desired end use, as is well known to those of ordinary skill in the art. The polymers may have a density of from about 0.85 to 0.98 g/cc as measured by ASTM standards. Preferred polymers include but are not limited to ethylene homopolymers and copolymers, propylene homopolymers of copolymers, butylene homopolymers and copolymers, isobutylene homopolymers and copolymers, styrene homopolymers and copolymers, butadiene homopolymers and copolymers, and acrylate homopolymers and copolymers. Preferred polymers include homopolyethylene, homopolypropylene, polyethylene-co-propylene, polypropylene-co-ethylene, polyethylene-co-butylene, polypropylene-co-butylene, polyethylene-co-propylene-co-diene, polyethylene-co-octene, butadiene-styrene die block and tri block copolymers, polymethylmethacrylate, and ethylene vinyl chloride.

### EXAMPLE 1

Preparation of the Sample Holding Device

This example describes the preferred process used to prepare the sample holding array 10. A 3.937 inch diameter×0.020 inch thick optical grade micro-crystalline silicon wafer (purity>99.999%), which was polished on both sides to a scratch and dig specification of 80/50, was used as the first substrate. The second substrate used was a 3.937 inch diameter×4 mm thick silicon slab with 56 holes or openings, mechanically drilled to a diameter 7.01 mm, and arranged in a 7 column by 8 row array. Each substrate was machined with a 45 mm flat edge which is used to align the substrates during preparation. Forty-eight of the openings are used for unknown samples, while the remaining eight openings are used for reference materials or background collection.

To prepare the substrates for bonding, the first substrate was rotated to approximately 3000 rpm and a spin coat adhesion promoter, vinyltriacetoxysilane (AP3000, obtained from The Dow Chemical Company), was manually added to the wafer. This produced an approximately 2-5 nm film of adhesion promoter onto the surface of the first substrate. After drying, the first substrate was rotated to approximately 500 rpm and benzocyclobutene (BCB, Cyclotene™ 3022-46, obtained from The Dow Chemical Company) was manually poured onto the wafer directly from bottle to minimize contamination. Once the benzocyclobutene had been added, the rate of rotation was increased to 1000 rpm to yield a final film thickness of approximately 5 microns Cyclotene™. The wafer was then baked on a hot plate at 140° C. for 3 minutes to evaporate the solvent. The film produced in this manner was dry to the touch and storable for up to one month.

A programmable hot press was used to bond the substrates together. The flat edges of the first and second substrates were aligned and placed in a machined holder to force the substrates to stay in alignment during the bonding process. The holder and substrates were placed in a heatable press between two platens at room temperature with the first substrate in contact the benzocyclobutene coating of the second substrate. The substrates were pressed together at 48.26 kPa (7 psi) and the platens ramped to a temperature of 149° C. (300° F.) over 15 minutes to allow the BCB to soften. The pressure was increased to 3.447 MPa (500 psi) and the temperature ramped to 210° C. (410° F.) and maintained for 1 hour to allow the BCB to cure. The temperature was then cooled to 38° C. (100° F.) and held for 30 minutes more. The pressure was then removed and the sample holding array allowed to cool to ambient conditions.

The cured Cyclotene™ was stripped out of the bottom of the cavities by soaking the sample holding array in benzenesulfonic acid for approximately 1 hour at 80° C. The sample holding array was rinsed with isopropanol and then a distilled water rinse. A brass scribe was used to remove any minimal remaining bonding material.

### EXAMPLE 2

Polymer Deposition Into the Cavities of the Sample Holding Device

The purpose of this example is to illustrate the preparation of polymer samples for analysis using the sample holding array and method of the invention. The samples can be prepared using a commercial high throughput polymer catalyst screening system for sample preparation such as described in U.S. Pat. No. 6,306,658. The reactors used in these systems are typically used for homogeneous and heterogeneous polymerization catalyst screening reactions. Post-reaction samples containing solvent and polymer are then transferred to a rotary evaporator to remove the solvent and any volatiles. The library of polymer samples is weighed robotically.

Ethylene/l-octene samples prepared are dissolved in 1,2,4-trichlorobenzene stabilized with 2,6-di-tert-butyl-4-methylphenol(BHT) (0.18 mg/ml) at 150° C. to a concentration of 30 mg/mL using a liquid handling robot and mechanically shaken to completely dissolve the polymer. The polymer samples (50-100 uL each) are then deposited using heated robotic arms into the sample wells of the infrared sample holding array. The samples are held at 150° C. for at least 30 minutes after the last deposition and the heating stage is turned off, allowing the large thermal mass to cool slowly to room temperature. The sample holding array is then mounted on a computer controlled rotating wheel in the sample compartment of the infrared spectrometer. A nitrogen-purged spectrometer is used for all infrared measurements. The first position and the last position at the first column are left empty for background measurements and the average of these two spectra was used as background. The background spectrum was reacquired after every 10 spectra were completed. An additional aperture (4 mm in diameter) was positioned in front of the wafer to reduce the size of the incident IR beam. The distance between the aperture and the wafer is about 10 mm, which allows the wheel to rotate freely. The addition of the aperture is to ensue that 100% of the IR beam falls into each well. This also allows a wide tolerance of the well positions for the fabrication of wells.

### EXAMPLE 3

Analysis of Ethylene/1-Octene Copolymer Composition and Density

A series of 26 ethylene/1-octene copolymer samples were selected for the calibration of the FTIR method using the sample holding array. The actual 1-octene mole percentage incorporation values were obtained from ¹³C NMR spectroscopy and spanned a range from 0 to 17 mole percent 1-octene. Actual densities were obtained using the standard ASTM method. A direct least square curve fitting procedure using the first derivative of the 1377 cm⁻¹ peak area normalized to the first derivative of the 1473 peak area was used for the calibration curve. Samples used in the calibration curve were prepared either via homogeneous or heterogeneous catalysts under both batch and continuous conditions. Five ethylene/1-octene copolymers were then chosen to validate the predictive capability of the model using the sample holding array of the invention. The results of these samples are shown below.

| | | Actual | Predicted | | |
|---|---|---|---|---|---|
| EO | 1st | mole % | mole % | Actual | Predicted |
| Sample | Derivative | 1-octene | 1-octene | Density | Density |
| 1 | −0.753 | 14.9 | 15.6 | 0.864 | 0.865 |
| 2 | −0.516 | 9.4 | 9.2 | 0.881 | 0.886 |
| 3 | −0.461 | 7.9 | 7.9 | 0.892 | 0.891 |
| 4 | −0.183 | 4.3 | 3.1 | 0.905 | 0.916 |
| 5 | −0.066 | 2.6 | 1.9 | 0.920 | 0.926 |

What is claimed is:

1. A sample holding array for retaining multiple samples for the purpose of infrared or near infrared transmission spectroscopy comprising:
a. a sample support which is at least partially transparent to infrared and near infrared radiation, the support having a first generally planar surface and a second opposed generally planar surface, the support being constructed of a material of the group consisting essentially of silicon, germanium, zinc sulfide, cadmium telluride, AMTIR-1, sapphire, KRS-5 or zinc selenide, the material of construction not containing impurities significantly detrimental to transmission of infrared or near infrared radiation through the thickness of the support, the support having a thickness which allows sufficient IR transmission to allow infrared and near infrared radiation transmission through the support for the purpose of spectroscopic analysis, and
b. an array of individual sample cavities defined adjacent to said first planar surface of the support, the cavities being in optical communication with the second planar surface of the support whereby infrared or near infrared radiation can be transmitted through the thickness of the support for the purpose of spectroscopic analysis of samples contained in said sample cavities, respectively.

2. The sample holding array of claim 1 comprising:
a. a first substrate which forms said sample support,
b. at least one adhesive coating layer bonded to the first generally planar surface of the first substrate,
c. a second substrate having a first generally planar surface and an opposed second surface, the first surface of the second substrate being bonded to the first surface of the first substrate through the adhesive layer,
d. the second substrate defining a plurality of openings extending between the first and second surfaces thereof and forming with the first surface of the first substrate an array of sample holding cavities, the portion of the first surface of the first substrate forming a part of the sample holding cavities being generally free of said adhesive layer to facilitate transmission of infrared and near infrared radiation through the first substrate into the interior of the sample holding cavities.

3. The sample holding array of claim 2 wherein the first substrate is bonded to the second substrate through an adhesive which has a temperature operating range up to at least 160 degrees Centigrade.

4. A method of infrared or near infrared analysis comprising placing sample in the sample cavities of the sample holding array of claim 1, irradiating the sample through the first substrate, and detecting the transmitted radiation passed through the sample material.

5. A method of Raman analysis comprising applying a reflective coating to the walls of the cavities of the sample holding array of claim 1, placing sample in the cavities, irradiating the sample cavities with laser radiation, and detecting the Raman back scatter to characterize the samples.

6. A method of x-ray fluorescence analysis comprising applying a reflective coating to the walls of the cavities of the sample holding array of claim 1, placing sample in the cavities, irradiating the sample cavities with x-ray radiation, and detecting the fluorescence back scatter radiation to characterize the samples.

7. A method of nanoindentation comprising placing sample in the sample cavities of the sample holding array of claim 1, and contacting the sample with a nanoindenting probe for the purpose of measuring one or more physical material properties of the sample.

8. The sample array of claim 1 wherein the sample support is constructed of silicon.

9. The sample array of claim 8 wherein the sample cavities are defined in a silicon material.
